(19) United States
(12) Patent Application Publication
(10) Pub. No.: US 2010/0026085 A1
(43) Pub. Date: Feb. 4, 2010

(54) BRAKE SYSTEM FOR AUTOMOTIVE VEHICLES

(76) Inventor: Zengxin Chen, Beijing (CN)

Correspondence Address: BIRCH STEWART KOLASCH & BIRCH, PO BOX 747, FALLS CHURCH, VA, 22040-0747, US

(21) Appl. No.: 12/515,099

(22) PCT Filed: Nov. 16, 2007
(86) PCT No.: PCT/CN07/03249

§ 371 Date: May 15, 2009

(30) Foreign Application Priority Data
Nov. 17, 2006 (CN) 200610145470.2
Jan. 16, 2007 (CN) 200710000832.3

(51) Int. Cl. B60T 1/06

(52) U.S. Cl. 303/151

(57) ABSTRACT

The said brake system for automotive vehicles of the present invention includes an energy-supplying device and a control device, wherein, further includes a wear-resistant component and a linkage component, when the vehicle is braked, the wear-resistant component is attached to a wheel and contacts with the ground, the linkage component is connected to the wear-resistant component and rotates with a shaft outside the wheel fixed to the frame. Under the control of the control device, the energy-supplying device rotates with the shaft outside the wheel, and the brake force is acted on the wheel through the linkage component and the wear-resistant component. Its energy-supplying device may include an elastic component and can turn the braking kinetic energy into elastic potential energy, and when the brake pedal is released, the elastic potential energy is turned into kinetic energy again. The present invention is different from the former design ideas, it can effectively improve the safety of the vehicles as well as save energy, and it is a great innovation in brake field. It can be used in automotive vehicles, such as electric bicycles, motorcycles, automobiles and so on.

### TECHNICAL FIELD

The present invention relates to a brake system, and especially to a brake system for automotive vehicles (including but not limited to motorcycles, automobiles, electric bicycles, etc.).

### BACKGROUND OF THE INVENTION

The brake systems for the existing automotive vehicles, such as electric bicycles, motorcycles, automobiles, etc, usually use friction to brake a vehicle. The brake system uses the friction between the brake disc and the wheel to prevent the wheel from rotating, and the friction between the wheel and the contact surface will prevent the vehicle from moving.

For those heavy and fast vehicles, it seems to be difficult just by the friction between the brake disc and the tire. To solve this problem, manufacturers and related scientific researchers always think about it from two aspects: first is to increase the friction between the tire and the ground, such as to design tires with high coefficient of friction, to wrap chains round the tire, and so on; second is to control the friction between the brake disc and the tire more safely and more smartly, such as to use improved brake disc, to introduce EBV (Electronic sche Bremsenkraft Verteiler) and ABS (Anti-lock Brake System), and so on. This could improve the braking performance to a certain extent.

Some other inventions referring to the following cited documents try to improve the braking performance by throwing obstacles to the wheel, throwing hooked articles to hook on to the ground, and so on. But these improvements could only be used in an emergency, and may cause some bad results.

### Cited Documents:

Ultra-short-distance directly ground brake system for automobiles, China, publication number: CN1621286A, publication date: Jun. 1, 2005.

Chain brake device for automobiles, China, patent number: CN1637270Y, patent date: Sep. 1, 2004.

Generally speaking, the brake systems for the existing automotive vehicles have the following problems:

1. The braking distance is too long.

The braking distance for the existing vehicles, especially for automobiles and trains, is still very long even though they are configured with advanced brake system, such as ABS and so on. The braking distance for automobiles at a speed of 100 km/h is longer than 30 meters. The poor braking efficiency is one of the major causes of traffic accident.

2. Energy is wasted.

The existing vehicles' fuel energy waste mainly exists in two aspects. The first energy waste exists before vehicle starting or during vehicle parking when the engine is idling. Because the power needed for vehicle starting is very great, the idling speed is usually set very high so as to avoid engine shutoff. The second energy waste comes from braking. When the vehicle is braked, the whole driving kinetic energy is turned into heat and then the heat is lost, so the braking energy is not stored and reused. This causes waste and pollutes the environment.

The reason for this is that we use the same tire during driving and braking. This requires that the friction between the tire and the ground should not be too large, or else the fuel consumption will be too high and the vehicle's speed will not be enough. But the friction between the tire and the ground should not be too small, or else the braking performance will get worse. Safety and fuel economy are at the two ends of a seesaw. Various vehicles try to find a suitable value of friction according to different vehicle types and different customers. But this always attends to one thing and loses another. Power is wasted as well as braking performance is not satisfying.

### SUMMARY OF THE INVENTION

Considering the shortcomings of the prior arts, the technical problem to be solved by the present invention is to provide a new kind of brake system for automotive vehicles. The brake system for automotive vehicles could get a better brake effect and save energy.

In order to accomplish the above purpose, the present invention uses the following technical solutions:

A brake system for automotive vehicles includes an energy-supplying device and a control device, wherein, further includes a wear-resistant component and a linkage component;

when the vehicle is braked, said wear-resistant component is attached to a wheel and contacts with the ground;
said linkage component on the one hand is connected to said wear-resistant component, and on the other hand rotates with a fixed shaft on the frame;
under the control of said control device, said energy-supplying device rotates with said fixed shaft on the frame, and the brake force acts on the wheel through the linkage component and the wear-resistant component. Wherein, the energy-supplying device is the device supplying brake force; the control device is the device controlling the duration and extent of the brake force.

When said brake force is an elastic deformation force, said energy-supplying device is an elastic component.

Said elastic component is a group of plane roll-up springs in parallel, and the control device control the number of plane roll-up springs which act on said fixed shaft.

When the brake pedal is released, said elastic component can alternatively tow said linkage component above or below the wheel, so that the automotive vehicle could move backwards or forwards.

When the brake pedal is released, said elastic component acts on the drive shaft between the engine and the gearbox.

When the vehicle is not braked, said wear-resistant component hides in the concave lines of the wheel.

Said wear-resistant component is track, whose both sides are connected to the linkage component.

Or, said wear-resistant component is of multi-layers structure connected by the elastic component in the middle.

Said wear-resistant component is fixedly connected to said linkage component which is on one side of the wheel and actively connected to said linkage component which is on the other side; said actively connection is connected when the vehicle is braked and disconnected when the vehicle is not braked.

Or, when the vehicle is braked, said wear-resistant component is connected to said linkage component, covers the wheel, and is apart from the wheel after passing the bottom of the wheel.

The coefficient of friction of one side of said wear-resistant component, which is in contact with the ground, is greater than the coefficient of friction of the other side which is in contact with the tire.

In the axial direction of said fixed shaft, there is a groove from the surface to the axis, there are several projections in said groove, in said axis there is an inserting bar, said projections protrude or immerge as the inserting bar is inserted or drawn back.

The brake system provided by the present invention can solve several technical problems people are eager to solve all the time. These problems including:

### 1. Safety

Because the wheel is attached with the wear-resistant component during braking, the coefficient of friction between it and the ground is very high, at the same time, the traction outside the wheel used to prevent the wheel from moving can be supplied, so that the controllability of brake is improved, the braking efficiency is enhanced, the braking distance is greatly shortened and the driving safety is improved. When the elastic component is used for providing brake force, the situation that the braking performance is influenced by water accumulating on the road or overheated friction disc due to continuous braking will not occur, and the reliability of braking is effectively improved.

### 2. Energy Saving

When the safety problem is solved, the coefficient of friction of the wheel during driving can be designed very low. This can effectively reduce the driving resistance, economize power, and save energy. When the elastic component is used to brake the vehicle, the idling speed of the vehicle can be adjusted very low to further save energy, because the energy stored by the elastic component can be used to assist vehicle starting.

### 3. Control Performance

When the elastic component is used, a part of the braking kinetic energy of the vehicle can be turned into elastic potential energy; when the brake pedal is released, the elastic potential energy can be turned into vehicle's kinetic energy. This can improve the control performance of the vehicle.

### 4. Choose Individually

The existing vehicles have just one set of tires. No matter it's raining or snowing, or it's summer or winter, there are no other choices for drivers to choose. However, the wear-resistant component of the present invention is easily to replace. Every vehicle can be equipped with several different wear-resistant components so as to accommodate different roads and drivers with different driving habits.

### BRIEF DESCRIPTION OF THE DRAWINGS

Now with the reference to the drawings and the embodiments, the present invention will be further described.

FIG. 1 is a schematic view of related parts' position of the linkage component in the brake system of the first embodiment;

FIG. 2 is a schematic view of related parts' position of the linkage component in the brake system of the second embodiment;

FIG. 3 is a schematic view of the structure of a portion of the tire in the brake system of the third embodiment;

FIG. 4 is a schematic view of related parts' position of the linkage component in the brake system of the third embodiment;

FIG. 5 is a schematic view of related parts' position of the linkage component in the brake system of the fourth embodiment;

FIG. 6 is a schematic view of the structure of a portion of the shaft 5 in the brake system of the fourth embodiment.

### DESCRIPTION OF THE PREFERRED EMBODIMENTS

The present invention adds a separate wear-resistant component and a separate linkage component to the existing brake system for automotive vehicles. When the vehicle is braked, the wear-resistant component is attached to a wheel and contacts with the ground, and the linkage component is connected to the wear-resistant component and rotates with a shaft which is outside the wheel and fixed to the frame. Under the control by a control device, an energy-supplying device rotates with the shaft which is outside the wheel and fixed to the frame, and the brake force acts on the wheel through the linkage component and the wear-resistant component.

The brake forces acting on the shaft or the linkage component are various, they can be elastic deformation force, braking force, brake force generated by engine exhaust and so on, and they maybe the composite force of the above forces.

The elastic deformation force is the counterforce, which is generated by deformation of an elastic component, used to prevent the shaft and the linkage component from rotating, and the deformation of the elastic component is caused by the traction of the linkage component when the vehicle is turning or slipping. The device using the elastic deformation force has the function of energy storage. When the brake pedal is released, it can alternatively tow the linkage component which is above or below the wheel so as to make the vehicle move forwards or backwards. The stored energy can be transmitted to the drive shaft between the engine and the gearbox to drive the vehicle when the brake pedal is released.

The elastic component mentioned here could be a group of plane roll-up springs in parallel. The control device controls the number of the plane roll-up springs acting on the bearing. When the brake pedal is released, the elastic restoring force of the elastic component can be alternatively tow the linkage component which is above or below the wheel, and at the same time it can also act on the drive shaft between the engine and the gearbox to output its stored energy.

The braking force is the force by which the brake system directly prevents the linkage component from rotating. The brake system is similar to those of the existing vehicles, and the difference between them is that: the former acts on the wheel through the shaft and the linkage component outside the wheel, and the later directly acts on the wheel.

The engine exhaust brake is a familiar auxiliary brake method. It tows the engine reversely by the linkage component or the bearing, and the engine acts as an air compressor to brake the vehicle.

The wear-resistant component attached to the wheel during braking, such as friction disc, track and so on, can be apart from the wheel during driving, and it is attached to the wheel only during braking. The wear-resistant component can also be on the wheel during driving, for example hided in the groove of the tire, and be spread over the wheel only during braking.

The friction discs don't need to be arranged compactly so as to get relatively high coefficient of rolling friction when the wheel is rolling and generate relatively large rolling friction; when the wheel is slipping, relatively large slipping friction can be achieved because the coefficient of friction between the wheel and the ground is relatively high. This is advantageous to quickly preventing the vehicles from moving.

The compactness between the wear-resistant component and the wheel has relation to the proportion of the automotive vehicles' kinetic energy turning into the elastic component's potential energy. The adjustment for compactness between the wear-resistant component and the wheel can be achieved by adjusting the length of the linkage component, the thickness of the wear-resistant component, the distance between the wheel and the shaft which is outside the wheel and fixed to the frame, and so on. The adjustment for the later can be coordinated according to the braking situation by the driver during the driving process.

The present brake system for automotive vehicle is different from the usual design idea of improving brake systems. It uses the wear-resistant component temporarily attached to the wheel during braking, so that the technical parameters of the wheel relative to the ground during braking and no-braking are totally different.

The advantage of this brake system is that the friction between the vehicle and the ground during braking is greatly increased. Not only the slipping friction between the ground and the vehicle is increased, and also the rolling friction is increased. According to the formula of slipping friction: f=μN, friction discs can increase the value of μ; according to the formula of rolling friction: M=δN, friction discs with appropriate gap can increase the value of δ. At the same time, by freely controlling the linkage component, the contact relationship between the wear-resistant component and the ground is in the state of intending to slip but no slipping, and the friction between the ground and the vehicle is always kept the largest (similar to the function of ABS).

This brake system can greatly reduce the friction between the tire and the ground during driving. This object can be totally achieved by choosing suitable tire material. Because it's not necessary to worry whether the friction is too small and the safety during braking is affected.

During the actual use, because the rear wheels of most of automobiles and motorcycles are not the steering wheels, the rear wheels may use the present brake system and the front wheels use the original brake systems. Now with the reference to the drawings, several embodiments are given to further describe the present invention.

### Embodiment 1

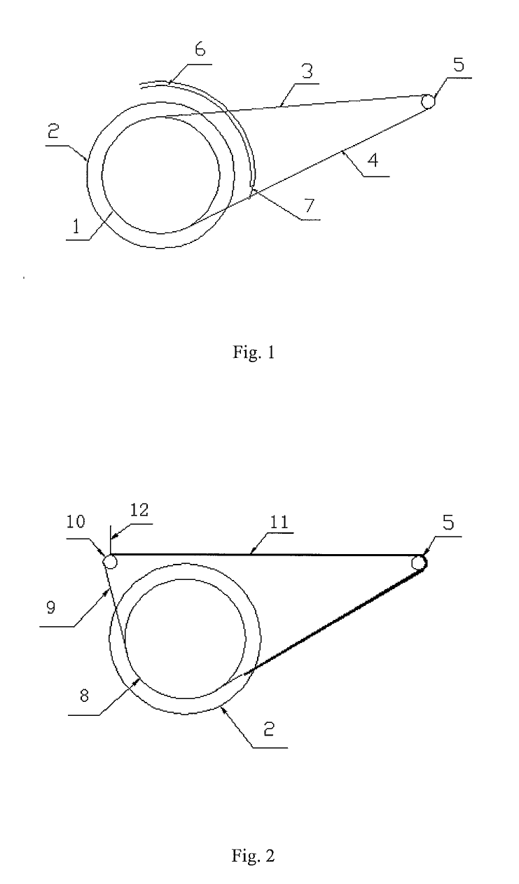

As shown in FIG. 1, gears 1 which can rotate along with a wheel 2 are disposed on the two sides of the wheel 2, and their radii are smaller than the radius of the wheel. Chains, which are on the gears 1 and act as linkage components, rotate with gears on a shaft 5 which is behind the wheel 2 and fixed to the frame. There are active hooks on the chains. When the vehicle isn't braked, the hooks stay on the chains 3. When the vehicle is braked, the hooks protrude by the movement of rails.

On the upper frame of the wheel are disposed friction disc cases 6 which act as wear-resistant components. The friction disc cases are similar to magazine device, contain spring, and can push the friction discs to the exit. The tails of the friction disc cases open behind the wheel, on which bars 7 is disposed, and the friction discs can be offloaded from the chains 4 acting as the linkage components and be thrust into the friction disc cases 6.

The friction discs are shallow U-shaped, are made of wear-resistant materials, and have certain strength. The outside surface of the disc is rougher than the inside surface. The inside width of the bottom of the shallow U-shape is equal to the width of the wheel, and the height of rims on the two sides equals to the distance from the hooks' protruding position to the wheel's rim. The rims on the two sides have openings which can be connected to hooks.

The rail is fixed to the frames on the two sides of the wheel, is controlled by a relay which acts as a control device, and uses the same circuit with braking taillights. When the vehicle is braked, the circuit is connected, the taillights are lighted, and the rail protrudes to move the hooks on the chains 3. Then the hooks hook on to the openings on the two sides of the friction discs, so that the friction discs are attached to the wheel 2 to rotate downwards. When the friction discs rotate downwards, the chains 3 are rotated, the chains 3, the gears and the shaft 5 rotate together, and then under the braking force, the shaft 5 and the rotating part of the energy-supplying device rotate together.

When the brake pedal is released, the circuit is disconnected, the rail is retracted, the hooks are drawn back by the elasticity, and the friction discs are retracted into the friction disc cases 6. At the same time, the linkage between the rotating part of the energy-supplying device and the shaft 5 is disconnected because of the released brake pedal, and then the shaft 5 rotates idle.

### Embodiment 2

As shown in FIG. 2, two grooves 8 are separately disposed on the two sides of the wheel 2 in the radial circumferential direction, and the radii of the grooves 8 are smaller than the radius of the wheel 2. A sliding bearing is disposed above the wheel, and a track 11 which acts as the wear-resistant component covers it. On the two sides of the track 11 are cables 9 which act as the linkage component. The cables 9 enclose the grooves 8 in the front and the lower parts of the wheel 2, a shaft 5 which is behind the wheel 2 and fixed to the frame, and the upper sliding bearing 10. A part of the cables 9, which is in front of the track 11 and whose length is about half of the wheel circumference, can slide relative to the track 11, and the front ends of the cables 9 are connected to the front end of the track 11 by elastic rope. The rear end of the track 11 is connected to the corresponding cables. In front of the sliding bearing 10 is a baffle 12. When the vehicle drives normally, the baffle 12 protrudes to prevent the track 11 from moving downwards with the cables 9. When the vehicle is braked, the baffle 12 is retracted, and the elastic rope quickly drags the track 11 downwards, then the track rotates with the wheel 2 and the bearing so as to transmit the friction between the ground and the track 11 to the shaft 5.

The control method for the rotation of the shaft 5 is the same with the usual control on the wheel by the common brake system, and they all use friction. At the same time, the shaft 5 rotates with the rotating part, that is, brake by the exhaust.

A relay as the control device is used to control the baffle 12, and it uses the same circuit with braking taillights. When the vehicle is braked, the circuit is connected, the baffle 12 is retracted, and the braking force prevents the shaft 5 from rotating; when the brake pedal is released, the baffle 12 falls to prevent the track 11 from continuing rotating while the opening of the track 11 is at the right place, at the same time, there is no braking force to prevent the shaft 5 from rotating and the cables 9 no longer rotates.

### Embodiment 3

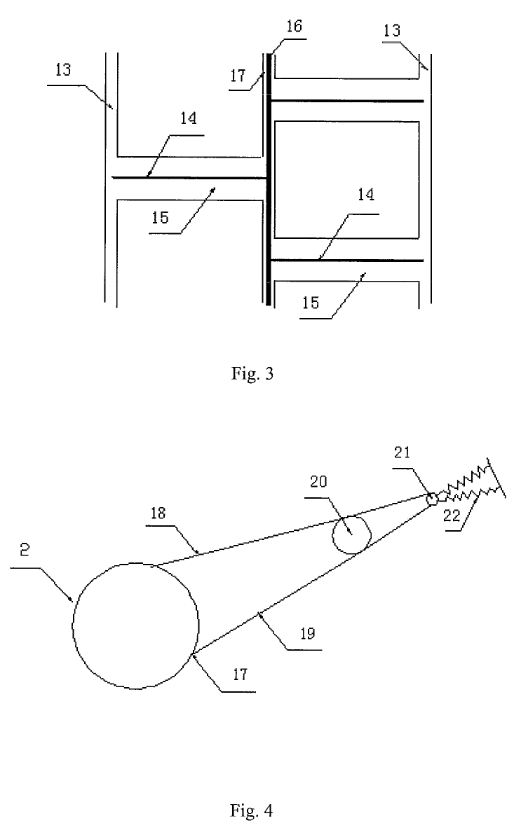

As shown in FIG. 3 and FIG. 4, in the middle of a wheel's 2 outer circumference, a groove 17 is disposed, in which there is a flywheel 16, and over the flywheel 16, there is a chain 18 acting as the linkage component. On the inner and outer sides of the outer circumference, a groove 13 is disposed respectively. In the axial direction of the outer circumferential surface of the wheel, several concave lines 15 are disposed, and friction cable 14 acting as the wear-resistant component are disposed in the concave lines 15. One end of the friction cable 14 is connected to a rotating part of the flywheel 16, the other end is connected to the grooves 13 on the two sides of the wheel, and it can slide in the grooves 13. The chain 18 rotates round a slipping ring 21 through a one-way gear 20 which is on a shaft. The shaft is outside, behind and above the wheel 2, and is fixed to the frame. On the slipping ring, there is a group of springs 22 the other ends of which are fixed to the frame.

As shown in FIG. 4, when the vehicle is braked, in the effect of the rightward traction of the springs 22, the friction cable 14 protrudes from the concave lines 13. The friction between the friction cable 14 and the ground further deforms the springs 22 to prevent the vehicle from moving. When the brake pedal is released, because of a one-way gear 20, the traction of the elastic component 21 only has an effect on the lower chain 19, so that the wheel 2 rolls forwards, and the friction cable 14 is retracted into the concave lines 13. When the elastic force is released, the flywheel 16 no longer rotates.

The driver, instead of the control device, can directly control the brake system to control when the one-way gear 20 starts rotating and in which direction it rotates, so as to control when and how the elastic restoring force will be released. The brake system can complete the braking process just by elastic restoring force, and can have braking force acted on the shaft on which the gear 20 is disposed so as to complete combined brake.

### Embodiment 4

As shown in FIG. 5, one disc 1 is disposed respectively on the inner and outer sides of a wheel 2. The radii of the discs are smaller than the radius of the wheel and the discs rotate with the wheel. Bulgy teeth are disposed on the disc 1 and mesh with chains 3 acting as the linkage component. The chains on both sides both rotate with a gear on a shaft 5 which is behind and above the wheel and fixed to the frame. There are T-shaped protuberances 24 on the chain which is over the disc on the inner side of the wheel. The protuberances are connected to the friction discs 23. The friction discs 23 can rotate 90 degrees around the protuberances 24. The openings on the other ends of the friction discs 23 are connected to the other chain.

On the position 25 of the frame behind the wheel, a solenoid controlled by a relay is disposed, and the electric source for the solenoid is the same with the electric source for brake. A rail is connected to the movable part of the solenoid, when the rail protrudes, the friction discs 23 on the chain 3 can be removed to catch the protuberances on the chain which is on the other side. When the brake pedal is released, the rail is retracted, the friction discs 23 cover over the chain 3 and are apart from the outside chain, then the friction discs 23 are no longer below the wheel 2 and no longer in contact with the ground.

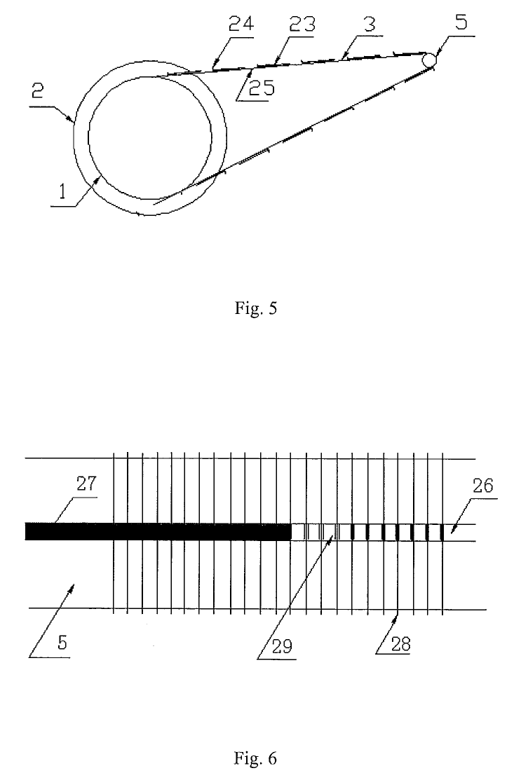

As shown in FIG. 6, on the shaft 5 fixed to the frame there is a group of plane roll-up springs 28. A groove 26 is in the axial direction of the shaft 5, from the surface to the axis. There are several projections 29 in the groove 26. In the axis there is an inserting bar 27. When the inserting bar is inserted, the projections 29 protrude from the surface of the shaft in turn. When the inserting bar is drawn out, the projections 29 immerge into the groove 26 again. When the projections 29 protrude, the plane roll-up springs 28 are connected to the shaft 5 to prevent the shaft 5 from rotating or drive the shaft 5 to rotate. The movement of the inserting bar 27 is controlled by the extent of the braking action.

On the shaft on which the gear locates there is a one-way valve. The valve makes the stored elastic potential energy not directly rotate the wheel reversely, but be transmitted to the drive shaft between the engine and the gearbox through transmission, so that the elastic potential energy can take the place of the engine to propel the vehicle.

The characteristic of this brake system is that the braking action and the releasing speed and extent of the elastic potential energy can be controlled independently, and the elastic potential energy can make the vehicle move forwards and backwards.

In the present embodiment, the coefficient of friction of friction discs' one side, which is in contact with the ground, is greater than the coefficient of friction between the tire and the ground. The friction discs should have a certain thickness so as to increase the coefficient of rolling friction. Additionally, the thickness of the friction discs, which are in front of the wheel, should be larger than that below the wheel, so that they have a certain rigidity or elasticity in front of the wheel, to prevent the wheel from rolling forwards. The friction discs meeting this requirement can be of multi-layers structure connected by elastic component in the middle. There can be replacement between the two layers, but when the displacement occurs, the thickness becomes less, and it has enough resistance.

Of course, there are other kinds of brake forces acting on the linkage component and the shaft outside the wheel. Besides friction cables, friction discs and track, there are other friction components which can be attached to the wheel during braking. Those skilled in the art can obtain these according to their experiences. No more detail will be described here.

The present invention is described above with reference to embodiments, but for those skilled in the art, the present invention has numerous variations and modifications which all fall within the scope of the invention, and the claims contain these variations and modifications.

1. A brake system for automotive vehicles includes an energy-supplying device and a control device, wherein, further includes a wear-resistant component and a linkage component;
when the vehicle is braked, said wear-resistant component is attached to a wheel and contacts with the ground;
said linkage component on the one hand is connected to said wear-resistant component, and on the other hand rotates with a fixed shaft on the frame;
under the control of said control device, said energy-supplying device rotates with said fixed shaft on the frame, and the brake force acts on the wheel through the linkage component and the wear-resistant component.

2. The brake system for automotive vehicles according to claim 1 wherein, when said brake force is an elastic deformation force, said energy-supplying device is an elastic component.

3. The brake system for automotive vehicles according to claim 2 wherein, said elastic component is a group of plane roll-up springs in parallel, the control device control the number of plane roll-up springs which act on said fixed shaft.

4. The brake system for automotive vehicles according to claim 2 wherein, when the brake pedal is released, said elastic component can alternatively tow said linkage component above or below the wheel, so that the automotive vehicle could move backwards or forwards.

5. The brake system for automotive vehicles according to claim 2 wherein, when the brake pedal is released, said elastic component acts on the drive shaft between the engine and the gearbox.

6. The brake system for automotive vehicles according to claim 1 wherein, when the vehicle is not braked, said wear-resistant component hides in the concave lines of the wheel.

7. The brake system for automotive vehicles according to claim 1 wherein, said wear-resistant component is track, whose both sides are connected to the linkage component.

8. The brake system for automotive vehicles according to claim 1 wherein, said wear-resistant component is of multi-layers structure connected by the elastic component in the middle.

9. The brake system for automotive vehicles according to claim 1 wherein, said wear-resistant component is fixedly connected to said linkage component which is on one side of the wheel and actively connected to said linkage component which is on the other side; said actively connection is connected when the vehicle is braked and disconnected when the vehicle is not braked.

10. The brake system for automotive vehicles according to claim 1 wherein, when the vehicle is braked, said wear-resistant component is connected to said linkage component, covers the wheel, and is apart from the wheel after passing the bottom of the wheel.

11. The brake system for automotive vehicles according to claim 1 wherein, the coefficient of friction of one side of said wear-resistant component, which is in contact with the ground, is greater than the coefficient of friction of the other side which is in contact with the tire.

12. The brake system for automotive vehicles according to claim 1 wherein, in the axial direction of said fixed shaft, there is a groove from the surface to the axis, there are several projections in said groove, in said axis there is an inserting bar, said projections protrude or immerge as the inserting bar is inserted or drawn back.

13. The brake system for automotive vehicles according to claim 2 wherein, said wear-resistant component is track, whose both sides are connected to the linkage component.

14. The brake system for automotive vehicles according to claim 3 wherein, said wear-resistant component is track, whose both sides are connected to the linkage component.

15. The brake system for automotive vehicles according to claim 4 wherein, said wear-resistant component is track, whose both sides are connected to the linkage component.

16. The brake system for automotive vehicles according to claim 5 wherein, said wear-resistant component is track, whose both sides are connected to the linkage component.

17. The brake system for automotive vehicles according to claim 2 wherein, said wear-resistant component is of multi-layers structure connected by the elastic component in the middle.

18. The brake system for automotive vehicles according to claim 3 wherein, said wear-resistant component is of multi-layers structure connected by the elastic component in the middle.

19. The brake system for automotive vehicles according to claim 4 wherein, said wear-resistant component is of multi-layers structure connected by the elastic component in the middle.

20. The brake system for automotive vehicles according to claim 5 wherein, said wear-resistant component is of multi-layers structure connected by the elastic component in the middle.
